(19) United States
(12) Patent Application Publication
(10) Pub. No.: US 2005/0126513 A1
(43) Pub. Date: Jun. 16, 2005

(54) On-board diesel oil and water emulsification system

(76) Inventor: Fredrick Hendren, Ontario (CA)

Correspondence Address: McFadden Fincham, Suite 606, 225 Metcalfe Street, Ottawa, ON, K2P 1P9, CA

(21) Appl. No.: 10/502,787

(22) PCT Filed: Jan. 28, 2003
(86) PCT No.: PCT/CA03/00104

Related U.S. Application Data
(60) Provisional application No. 60/352,237, filed on Jan. 29, 2002.

(51) Int. Cl. F02B 47/02

(52) U.S. Cl. 123/1 A

(57) ABSTRACT

A fuel system for feeding a non-stable emulsified fuel to a diesel engine, the improvement comprising a non-stable oil-in-water emulsion in which at least 90 percent of the droplets are less than 1 micrometer in diameter and the mixing chamber is positioned in relatively close proximity to the diesel engine such that the emulsion does not substantially de-emulsify between the mixing chamber and the diesel engine.

### FIELD OF THE INVENTION

The invention refers to an emulsified fuel and more particularly to an emulsified fuel of diesel oil-in-water with or without the use of a surfactant.

### BACKGROUND OF THE INVENTION

The impact of diesel fuels both environmentally and with regard to air pollution has been the subject of considerable research and patent matter. The main air pollutants from diesel engine exhaust gas are carbon monoxide (CO), nitrogen oxides (NOₓ), carbon dioxide (CO₂), hydrocarbons and particulate matter. The specific composition of emulsions is important to the fuel industry with regard to the stability of the emulsion, namely usefulness during transportation and the various contaminants which may effect the stability of the emulsion following the use of additives during operation.

It is well known in the industry that NOₓ emissions from diesel engines are reduced by mixing water in the diesel fuel which in turn reduces combustion temperatures. The emulsified fuel optimizes combustion by which, in turn, reduces nitrogen oxides, the major cause of air pollution. In this regard, moisture in the form of particles is homogeneously contained in the emulsified fuel, the fuel limits the generation of high temperatures in local areas in the flame and further, 20 to 30 volume % of moisture lowers the combustion temperature, primarily through latent heat of evaporation. Therefore the emulsified fuel limits the generation of nitrogen oxides by preventing high temperatures in local areas. The water is proportionately mixed into the diesel fuel and the mixture is injected into the cylinders. When water is added to the fuel, one of the two liquids disperses into the other liquid, and emulsion occurs thereby. Since the appropriately mixed emulsion is formed in a stable condition, the separation between water and fuel before combustion is not in issue. However, an anionic surfactant is usually present in the water to enhance dispersion and permeation of the chemicals which are added together with the water. The disadvantage of introducing a surfactant is the penalizing factor towards engine performance characteristics.

An emulsified fuel is typically prepared by mixing the fuel with a water mixture containing a surfactant, for example, mixtures of natural surfactants such as sulfates, sulphonates and carboxylates, or the like. The use of surfactant allows for small, medium or large systems to operate without any control means to constantly maintain the optimal ratio of combustible fuel to water.

With the use of surfactants, the engine will continuously incur power loss penalty resulting from the addition of water to the fuel mixture as fuel has no potential for thermal energy. Further during cold temperature operations, the water content is a concern for fuel flow and exhaust emission reduction potential is minimized.

Fuel emulsification based on diesel fuel+water+surfactant is presently being demonstrated in a number of different mobile source fleets, as a means of reducing oxides of nitrogen. Test results have indicated reductions in oxides of nitrogen ranging from 15 to 30%, particulate reductions from 0 to 30% and power losses in the range of 10 to 15%.

For applications where a loss in power for some activities is not an option or cold temperature is a concern for fuel flow, the emulsification technology using a surfactant is not an option for exhaust emissions reduction.

U.S. Pat. No. 6,211,251 discloses a known type of fluid emulsification system having primary and secondary fluids. The fluids are delivered by injectors to combine an air-fuel mixture in an emulsion tube which includes obstructions to assist in emulsifying the mixture. The difficulty to be overcome by the present invention being that the water added to such an emulsification system that is not combusted by the engine will result in premature corrosion of the cylinders and various other components of the engine. Thus, the life of the engine is significantly reduced.

The purpose of the invention is therefore to provide a system which allows for the same oxides reductions based on the use of a surfactant with the additional flexibility to allow the diesel engine (such as an on-board engine in a marine vessel) to achieve full power in critical situations.

### SUMMARY OF THE INVENTION

In accordance with the present invention, there is provided a fuel system for feeding fuel to a diesel engine, particularly a means for variably feeding an excess of a non-stable emulsion of blending agent in diesel fuel to said diesel engine, recovery means for recovering excess fuel fed to the diesel engine, and separating means associated with the recovery means for separating of the recovered non-combusted fuel into its component parts.

It is desirable the above further includes a means for blending a plurality of blending agents.

Desirably, the above includes an emulsifier means for forming a non-stable water in oil emulsion in which at least 90% of the droplets are less than 1 um in diameter, and the system comprises a water source, a diesel oil source and a mixing chamber having an agitation means for forming the non-stable emulsion mixture, the first and second sources include a signal means and a pump means.

Preferably, the agitation means is a propeller capable of having revolutions of 2500 to 6000 RPM, the recovery means comprises a non-stable emulsification of blending agent and diesel oil separating into its separate components and a recovery chamber having one or more channels, and the system is an on-board system.

In a preferred embodiment of the above, one of the channels recover diesel oil from said non-stable emulsification of blending agent and diesel oil.

In another embodiment of the present invention, there is provided a closed loop system for feeding fuel to a diesel engine having the above embodiments and the closed loop including a source of diesel oil, a source of blending agent, valve means for controlling fluid flow from the source of water, a mixing chamber having agitation means for forming an emulsion mixture, a microprocessor means for controlling the valve means and fluid flow a diesel engine, the separating means includes a diesel return flow and a blending agent return flow, the water return flow being operatively associated with the source of blending agent, and the diesel return flow being associated with the source of diesel oil.

It is also a preferred embodiment of the present invention wherein a method of feeding fuel to a diesel engine in a closed loop system includes the steps of:
forming of a variable non-stable emulsion comprised of a blending agent and diesel fuel,
feeding an excess of the non-stable emulsion to a diesel engine,
separating the excess amount into the component parts of the emulsion, and
recovering excess amounts of the emulsion not combusted by said engine.

Further in a preferred embodiment of the above, the above steps include the system comprising a mixing chamber having an agitation means, the first and second sources include a signal means and a pump means, the agitation means is a propeller having revolutions of 2500 to 6000 RPM, the recovery means comprises an non-stable emulsification of water and diesel oil separating into its separate components and a recovery chamber having one or more channels, and system is an on-board system.

Moreover, a further preferred embodiment, one of the channels recovers diesel oil from the non-stable emulsification of water and diesel oil.

It should be noted that more than one nozzle may be used to provide more than one blending agent to be mixed into the emulsion.

In the above embodiments, it is further preferable the system is an on-board system.

Having thus, generally described the invention, reference will now be made to the accompanying drawings.

### BRIEF DESCRIPTION OF THE DRAWINGS

FIG. 1 is a schematic view of a system in a preferred embodiment of the present invention.

### DETAILED DESCRIPTION OF THE DRAWINGS

The overall system of the present invention is designated by the reference numeral 100, and includes a continuous loop or closed circuit operation, for use of a non-stable emulsion of water-in-diesel fuel as a feed for fuel to a diesel engine 40 such as those used in a marine vessel. In the system 100, a water source 20 is connected to a metering device 23, such as a proportional control valve, which meters the flow of the water volume to be mixed.

The diesel oil source 10 and the water source 20 are each fed to a mixing chamber 30 through feed pipes 15 and 17 by pumps 25 and 27. In another embodiment of the present invention, where it is desired to use minor amounts of a surfactant for the emulsion system otherwise used herein it will be understood that a suitable source of surfactant may be provided and likewise, a proportional control valve may be used to meter the amount of surfactant for Use in the present invention.

The blending agent is then added to the fuel, through a nozzle (not shown) connected to the fuel pipe carrying the diesel to the mixing chamber. More than one nozzle can be added to the fuel delivery pipe for the capability of adding more than one blending agent to the base fuel. The nozzle is designed to disburse the blending agent into the flowing base fuel. The flow rate of the blending agent is, determined by the feed back signals to the system microprocessor 110 from the fuel flow sensor 50 and the engine speed.

An algorithm in the microprocessor software determines the volume of blending agent to be delivered to the nozzle. An output signal from the microprocessor to a proportional solenoid valve 25 controls the volume of blending agent pumped to the nozzle. The low rate of the blending agent is measured continuously by a flow meter prior to the nozzle. The flow meter signal is used to verify that the flow rate matches the theoretical value. The proportional solenoid valve 25 is adjusted accordingly. The time base for the measurement and adjustment of system parameters is on per second basis.

The pressure of the blending agent mass flow delivered to the nozzle is measured by a pressure transducer (not shown). This pressure is maintained above a minimum set value to ensure that the mass flow rate has enough energy to be thoroughly disbursed into the base diesel fuel flow.

Just down stream of the nozzle, the high speed paddle 35 comes into contact with the mixture of the blending agent and the base diesel fuel. The shearing force from the high speed rotating paddle results in the blending agent being completely dispersed into the base diesel. For liquid blending agents, diesel fuel emulsions are formed where micro droplets of the liquid blend agent are suspended in larger volumes/droplets of the base diesel fuel. The blend agent droplets will remain in suspension for a short period of time without the necessity to add surfactants in order to maintain the phase separation. The emulsion/blended fuel is to be injected into the combustion chamber prior to phase separation occurring. For fuel blends where the blending agent is gaseous (eg. methane), the mixing chamber creates micro bubbles of gas that are entrained throughout the base diesel fuel.

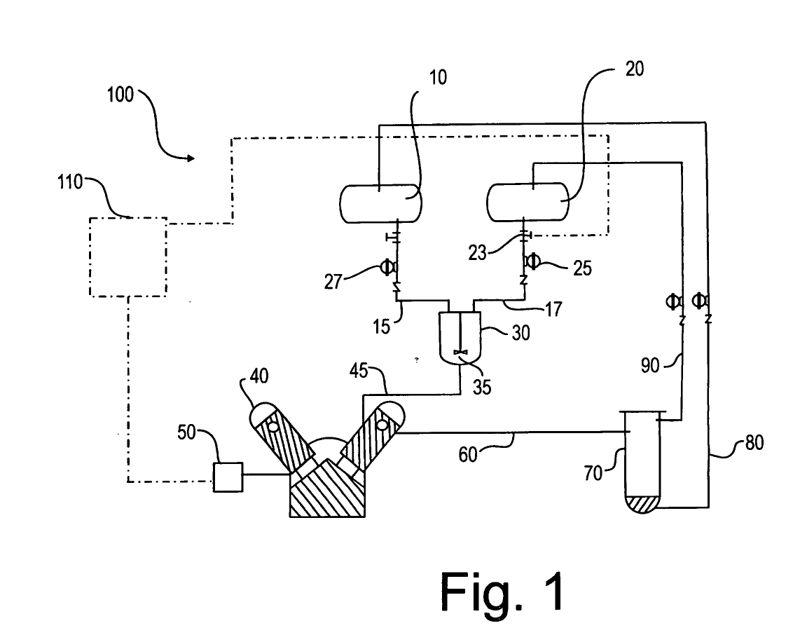

A mixing chamber combines the water from the water feed 17 and the diesel oil from the diesel oil feed 15. As the water and diesel oil combine, the mixture is subjected to an emulsification step using emulsifier means 30 to form the components as an emulsified fuel feed. Depending on the type of diesel engine and other variables, up to about 40% of the emulsion mixture is comprised of water; in more preferred embodiments, 5 to 35% of the emulsion volume is comprised of water and more desirably, 10 to 30%. The emulsifier means may be any suitable agitation means capable of forming a non-stable oil-in-water emulsion, preferably of the type in which at least 90% of the droplets are less than 1 μm in diameter. Typically, the emulsifier means may be of a type such as a shear mixer (shown in FIG. 1) located in the mixing chamber and which shear mixer 35 is capable of having a speed of at least 2500 to 6000 RPM. At such a shear mixing, a suitable non-stable fuel emulsion of a beneficial nature can be produced for use in the system of the present invention.

The emulsion is then fed to the diesel engine 40 by way of a feed line 45 to the fuel injector pump (not shown) where the fuel pressure is increased, after which it is directed to the individual combustion chamber fuel injectors; preferably, the mixing chamber is positioned in relatively close proximity to the diesel engine 40 such that the emulsion does not substantially de-mulsify between the mixing chamber 30 and the diesel engine 40. Thus, the length of feedline 45 is desirably short enough so that when relatively slow combustion levels of fuel are used the fuel emulsion mixture remains substantially intact.

In accordance with this invention, excess emulsified fuel is then fed to the injectors (not shown) of the diesel engine 40. This feed system includes recovery means for the recovery of non-utilized or excess fuel from the injectors (not shown). To this end, the recovery system of the present invention includes a sensing means, and a means for recovering and separating excess emulsified fuel.

During operation, the load of engine 40 determines the rate of fuel mixture being delivered to the injectors (not shown) in the engine 40. A sensing means 50 in conjunction with the engine load provides a signal to a controlling means 110 for the flow rate of the water from the water source 20 to be adjusted according to the fuel flow rate in the engine 40. Upon determining the appropriate conditions for adjusting the water flow rate in the system, the controlling means 110 signals a valve 25 to open or close accordingly. The excess emulsion fuel mixture not used during operation may then be fed through an outfeed line 60 which feeds the excess emulsified fuel to a separating means 70.

The separating means 70 allows for the recovered non-combusted fuel to separate into its component parts. Any suitable equipment for separating water from the fuel to obtain substantially pure component parts can be used; typically, separators such as centrifugal separators are known for this purpose. From the separator 70, water is then fed back to the water source 20 through a recovery feed line 90 and the diesel oil is fed back to the diesel oil source 10 through a separate recovery feed line 80 whereby these components can be reused.

For many diesel engine technologies, up to 96% of the fuel flow to the injectors is returned to the fuel tank, as this excess fuel serves coolant for the fuel injectors. Depending on the blending agent that is being used, it would be necessary under certain conditions to remove the agent from the fuel blend that is being returned to the fuel tank. For example, if water was being used as the blending agent 20, the fuel would create operational problems in cold weather conditions, as the water has the potential to phase separate and then freeze in the fuel tank. Under these conditions, the water would be demulsified from the diesel fuel on the return to the fuel tank. This process is accomplished by using techniques which will separate different liquids and gaseous substances based on the differences in thermal properties. The waste heat from the engine exhaust provides the energy to separate the blended substances. After separation, the base diesel fuel is returned to the fuel tank and the blending agent is recaptured and recycled through the emulsification/blending system.

The system control microprocessor 110 allows for the operator to input the quantity of blending agent to be added to the base fuel for specified operating conditions. For example, if water is the blending agent 20, then it would not be possible to achieve a condition of rated engine horsepower with the diesel—water emulsion, as the energy content available from the combustion of water is zero. For full power conditions the operator would input zero percent blending agent which would result in 100% diesel fuel being delivered to the fuel injectors.

The continuous monitoring and adjustment of the fuel blend being delivered to the engine's 40 combustion chambers provides for the optimization of the fuel combustion and exhaust emissions process for cold starting, particulate formation at part throttle and under high load, high speed conditions and oxides of nitrogen curing high load, high speed conditions and the reduction of Green House Gases through both life cycle CO₂ reductions and improved fuel efficiency.

Where the use of a surfactant is preferred, separate recovery means for the surfactant component, for example, crude oil or hydrocarbons, may also be detected and the surfactant component may then be returned to its source of origin.

Those skilled in the art will appreciate that any type of conventional signal processor may be used for providing signals to the system and further details regarding the sensor will not be outlined herein.

It is therefore evident from this disclosure that an emulsified fuel can be formed and recovered for re-use in the system. The present invention 100 enables excess fluids such as diesel oil and water to be returned to their points of origin and reused in the system without penalizing engine performance characteristics.

It is also understood by those skilled in the art to which the invention pertains that the invention has been described by way of a detailed description of a preferred embodiment and departures from and variations to this arrangement may be made without departing from the spirit and scope of the invention, as the same set out and characterized in the accompanying claims.

1. In a fuel system for feeding fuel to a diesel engine, the improvement comprising:
means for variably feeding an excess of a non-stable emulsion of blending agent in diesel fuel to said diesel engine,
recovery means for recovering excess fuel fed to said diesel engine, and
separating means associated with said recovery means for separating of the recovered non-combusted fuel into its component parts.

2. The fuel system of claim 1, further including means for blending a plurality of blending agents.

3. The fuel system of claim 1 or 2, including an emulsifier means for forming a non-stable water in oil emulsion in which at least 90% of the droplets are less than 1 um in diameter.

4. The system of claim 1, wherein said system comprises a water source, a diesel oil source and a mixing chamber having an agitation means for forming said non-stable emulsion mixture, said first and second sources include a signal means and a pump means.

5. The system of claim 6, wherein said agitation means is a propeller capable of having revolutions of 2500 to 6000 RPM.

6. The recovery system of claim 1, wherein said recovery means comprises an non-stable emulsification of blending agent and diesel oil separating into its separate components and a recovery chamber having one or more channels.

7. The recovery system of claim 6, wherein one of said channels recover diesel oil from said non-stable emulsification of blending agent and diesel oil.

8. The recovery system of claim 1, wherein said system is an on-board system.

9. A closed loop system for feeding fuel to a diesel engine comprising:
the fuel system of claim 1 or 2,
said closed loop including a source of diesel oil, a source of blending agent, valve means for controlling fluid flow from said source of blending agent, a mixing
chamber having agitation means for forming an emulsion mixture, a microprocessor means for controlling said valve, means and fluid flow a diesel engine,
said separating means including a diesel return flow and a blending agent return flow,
said blending agent return flow being operatively associated with said source of blending agent,
and said diesel return flow being associated with said source of diesel oil.

10. The system of claim 9, wherein said blending agent source and said diesel oil source further include a signal means and a pump means.

11. The system of claim 10, wherein said agitation means is a propeller having revolutions of 2500 to 6000 RPM.

12. The closed loop system of claim 9 wherein there is further provided blending means for a plurality of blending agents.

13. The recovery system of claim 1, wherein said recovery means comprises an non-stable emulsification of water and diesel oil separating into its separate components and a recovery chamber having one or more channels.

14. The recovery system of claim 13, wherein one of said channels recovers diesel oil from said non-stable emulsification of blending agent and diesel oil.

15. The recovery system of claim 13, wherein said system is an on-board system.

16. The closed loop system of claim 9, wherein said system is an on-board system.

17. In a method of feeding fuel to a diesel engine in a closed loop system, the improvement comprising the steps of:
forming of a variable non-stable emulsion comprised of a blending agent and a diesel fuel,
feeding an excess of said non-stable emulsion to a diesel engine,
recovering excess amounts of said emulsion not combusted by said engine, and
separating said excess amount into the component parts of said emulsion.
